(19) United States
(12) Patent Application Publication
(10) Pub. No.: US 2008/0086922 A1
(43) Pub. Date: Apr. 17, 2008

(54) LUMINOUS SIGN WITH ENCAPSULATED LED CHIPS

(75) Inventors: Bishou Chen, Shanghai (CN); Shikang Zhou, Shanghai (CN); Xin Cheng, Shanghai (CN); Bin Zhang, Shanghai (CN); Sheng Li, Shanghai (CN)

Correspondence Address: SEED INTELLECTUAL PROPERTY LAW GROUP PLLC, 701 FIFTH AVE, SUITE 5400, SEATTLE, WA, 98104, US

(73) Assignees: Shanghai Sansi Electronic Engineering Co., Ltd., Shanghai (CN); Shanghai Sansi Technology Co., Ltd., Shanghai (CN)

(21) Appl. No.: 11/852,209

(22) Filed: Sep. 7, 2007

(30) Foreign Application Priority Data
Sep. 7, 2006 (CN) 200610030911.4

(51) Int. Cl. G09F 13/00

(52) U.S. Cl. 40/550

(57) ABSTRACT

A luminous sign using encapsulated LED chips with a neon light effect, comprising: a light guide, the front shape of which is the shape of a character with a selected width and height; an illumination channel, the shape of which is matched the shape of the light guide, the illumination channel and the light guide integrated into one piece; at least one PCB, the shape of which is matched the shape of the illumination channel, being placed underneath the illumination channel; a plurality of LED chips being spacedly disposed as a linear or strip array on the PCB by chip bonding method; the light guide, the illumination channel and the PCB form a closed light cavity, encapsulated with encapsulant doped with diffusion diluent; the encapsulated light guide, illumination channel and PCB are mounted on a supporting frame to form a character shape.

### BACKGROUND

1. Technical Field

This disclosure relates to luminous signs.

2. Description of the Related Art

At present, most of luminous advertisements or other signs are made from neon tubes, incandescent lamps or fluorescent lamps.

However, those prior arts have many shortcomings. The service life of the incandescent lamps or the fluorescent lamps is short, and the neon tubes generate a large amount of heat. Furthermore, neon tubes have large power consumption and high operation cost.

In addition, the incandescent lamp and fluorescent lamp are extremely fragile to any physical impact, and need professional installation and maintenance. They also have other shortcomings, such as high driving voltage, being unsafe, large volume, inconvenient transportation, etc.

Recently, LED technology has been introduced into the field of simulative neon lights. However, nowadays, most solutions solder LED lamps that are commercially available to PCBs to form an illuminator. These solutions also bring the following two shortcomings:
1. Space distribution of light and light effect loss is not uniform;
2. Cost is relatively high.

### BRIEF SUMMARY

In order to overcome the above shortcomings, an embodiment provides a luminous sign using encapsulated LED chips configured to produce a neon light effect, through which the advertisement function similar to the neon light effect can be carried out, while the cost is reduced.

In one embodiment, a luminous sign using encapsulated LED chips with a neon light effect comprises: at least one light guide, the front shape of which is the shape of a character with a selected width and height; illumination channel with at least one side of opaque materials, the shape of which is matched the shape of the light guide, the illumination channel and the light guide is integrated into one piece; at least one PCB, the shape of which is matched the shape of the illumination channel, being placed underneath the illumination channel; a plurality of LED chips being spacedly disposed as a linear or strip array on the PCB by chip bonding method.

In one embodiment, the light guide, the illumination channel and the PCB form a closed light cavity, encapsulated with encapsulant doped with diffusion diluent; the encapsulated light guide, illumination channel and PCB are mounted on a supporting frame to form a desired character shape.

In one embodiment, the LED chips can also be encapsulated by separately dropping gel on the front.

In one embodiment the light guide is made of translucent materials, of which the inner wall has a smooth surface and the outer wall has a fine frosted surface.

In one embodiment, the two sides of the illumination channel are made of opaque materials, the illumination channel is pressed with the light guide to form a single piece by a secondary injection molding, the illumination has an inner wall having a smooth reflecting surface or coated with other reflecting materials.

In one embodiment, the LED chips being disposed on the PCB by chip bonding are connected to a controller through current-limiting resisters and wires.

In one embodiment, the encapsulant doped with diffusion diluent is silica gel.

In one embodiment, the PCBs have holes for dispersing the gel.

In one embodiment, the outer walls of the illumination channel can be fixed on the supporting frame through a plurality of matching flexible clasped-structures, which are positioned at corresponding locations of the illumination channel and the supporting frame.

In one embodiment, shoulders and flexible clasps are provided at the lower end of the illumination channel for fixing PCBs.

An embodiment provides an illuminator using encapsulated LED chips with similar appearance and luminous effect to the neon-light luminous sign, advertisement or art wares. In an embodiment, the illuminator includes a light guide shaped of signs, characters, numerals or strokes, a illumination channel being provided underneath the light guide, a PCB being provided underneath the illumination channel; the light guide, the illumination channel, and the PCB forming a closed light cavity. A serial of LED chips are deposed within the light cavity below the light guide, and are fixed on PCB by a chip bonding method. According to the different width of the light guide, LED chips distributes as a linear shape or a strip shape. The closed light cavity is encapsulated or filled with silica gel or other encapsulants. The light emitted from LED chips focuses on the translucent light guide through reflection, diffusion and focusing by the light cavity, making the whole space of the light guides to be illuminate and obtaining a similar effect to neon lights.

In an embodiment, a luminous sign using encapsulated LED chips with a neon light effect comprises at least one light guide, a front shape of which is a shape of a character with a width and height; an illumination channel with at least one side of opaque materials, having a shape which corresponds to the shape of the light guide, the illumination channel and the light guide integrated into one piece; at least one PCB, having a shape which corresponds to the shape of the illumination channel, being placed underneath the illumination channel; a plurality of LED chips disposed as a strip array on the PCB by a chip bonding method; the light guide, the illumination channel and the PCB configured to form a closed light cavity, the LED chips being encapsulated with encapsulant doped with diffusion diluent; the encapsulated light guide, illumination channel and PCB mounted on a supporting frame to form the character shape. In an embodiment, the LED chips are encapsulated by separately dropping gel on each LED chip in the plurality of LED chips. In an embodiment, the light guide is made of translucent materials and has an inner wall with a smooth surface and an outer wall with a fine frosted surface. In an embodiment, two sides of the illumination channel are made of opaque materials, and the illumination channel is pressed with the light guide to form a single piece by a secondary injection molding, the illumination having an inner wall with a smooth reflecting surface. In an embodiment, the LED chips are coupled to a controller through current-limiting resisters and wires. In an embodiment, the encapsulant doped with diffusion diluent is silica gel. In an embodiment, the PCB has holes for dispersing the gel. In an embodiment, outer walls of the illumination channel are configured to be fixed on the supporting frame through a plurality of matching flexible clasped-structures, which are positioned at corresponding locations of the illumination channel and the supporting frame. In an embodiment, shoulders and flexible clasps are provided at the lower end of the illumination channel for fixing PCBs. In an embodiment, the LED chips are encapsulated by filling the cavity with the encapsulant.

In an embodiment, an electric sign comprises: means for guiding light to form a selected shape; means for reflecting light into the means for guiding light; means for generating light; means for encapsulating the means for generating light; and means for coupling the means for generating light to the means for reflecting light. In an embodiment, the means for guiding light comprises a light guide having a frosted outer surface with the selected shape. In an embodiment, the electric sign further comprises a plurality of diffusion diluents dispersed within the light guide. In an embodiment, the means for generating light comprises an LED chip and the means for encapsulating the means for generating light comprises a silicon gel. In an embodiment, the means for generating light comprises a plurality of LED chips and the means for encapsulating comprises a silicon gel filling a cavity defined by the means for guiding light, the means for reflecting light, the means for generating light and the means for coupling the means for generating light to the means for reflecting light. In an embodiment, the means for generating light comprises a plurality of LED chips and the means for encapsulating comprises a corresponding plurality of drops of silicon gel deposited on respective LED chips in the plurality of LED chips. In an embodiment, the silicon gel comprises a soft silicon gel doped with a plurality of diffusion diluents.

In an embodiment, an electric sign comprises: a controller; and a plurality of characters coupled to the controller, each of the plurality of characters comprising: a circuit board having a general shape corresponding to a shape of a respective character in the plurality of characters; a plurality of light-emitting chips covered with light-dispersing encapsulant and coupled to the circuit board; a light-reflecting channel coupled to the circuit board; and a lens coupled to the light-reflecting channel. In an embodiment, the light-dispersing encapsulant of a respective character comprises a plurality of drops of silicon gel covering respective light-emitting chips in the plurality of light-emitting chips. In an embodiment, the circuit board, the plurality of light-emitting chips, the light-reflecting channel and the lens of a respective character define a cavity, and the light-dispersing encapsulant comprises a silicon gel filling the defined cavity of the respective character.

Embodiments may have good effects, simple structure, low price, long durability, high efficiency, long service life, low-voltage supply, and sturdiness.

### BRIEF DESCRIPTION OF THE SEVERAL VIEWS OF THE DRAWINGS

Through the following embodiments and the brief description of the drawings, the purpose, concrete structure and advantages of embodiments can be further understood, wherein:

FIG. 1 shows a perspective view of an advertising sign according to an embodiment;

FIG. 2 shows a longitudinal section view along the centre of a character stroke;

FIG. 3 shows a transverse section view of a character position vertical to the character stroke;

FIG. 4 shows a cross section of the light cavity composed of the light guide, the illumination channel and the PCB;

FIG. 5 shows an example drawing of a PCB (PCB of letter “O”);

FIG. 6 shows another embodiment of a cross section of a light cavity formed by a light guide, an illumination channel and a PCB.

### DETAILED DESCRIPTION

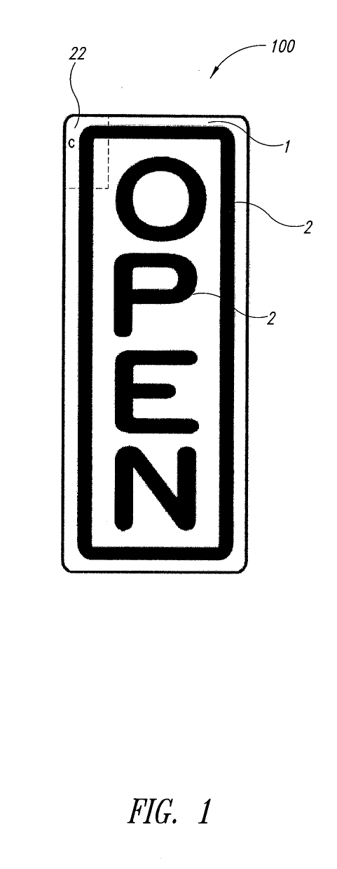

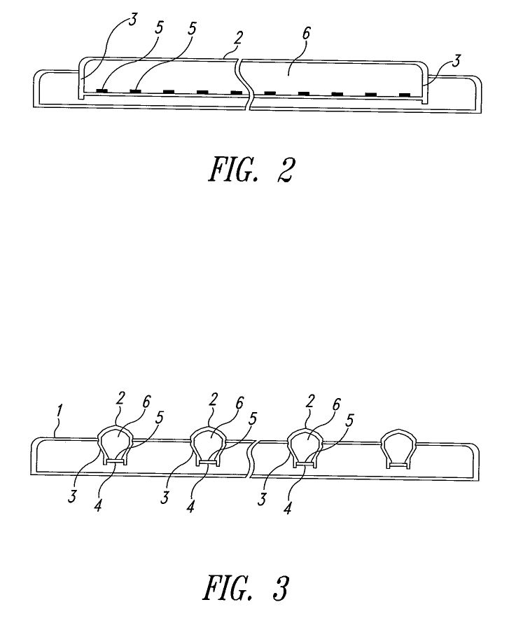

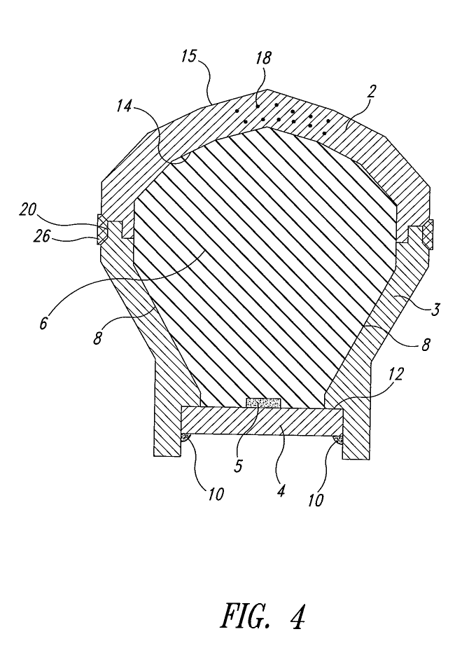

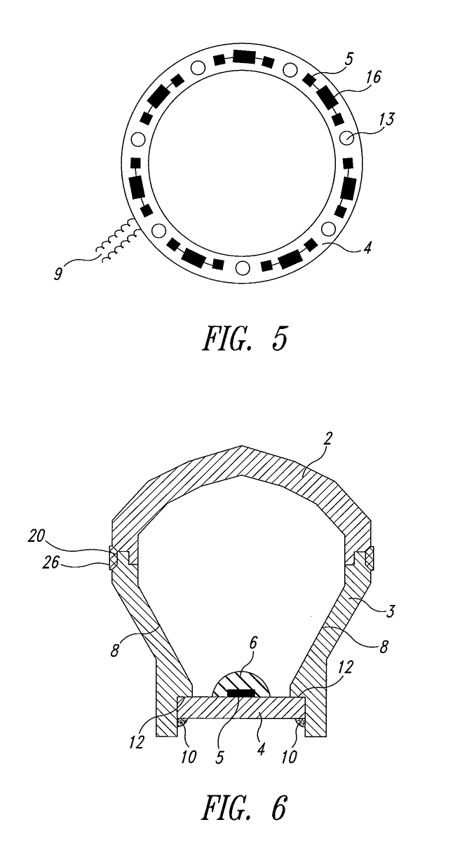

FIGS. 1 to 5 show the structure of an embodiment of a system 100, such as an electric sign, comprising: a supporting frame 1, which can be molded by black ABS plastic materials. Here shows a simple shape: square, however, other beautiful shapes can also be used. A PCB 4 that has a similar outline to the displayed character outline is used instead of a whole-piece PCB (for example, for character “O” in “OPEN”, the O-type PCB is be utilized). Each letter as shown in FIG. 1 can also be separated, i.e. there are no plastic materials connecting among the characters, so that the structure of the advertisement supporting frame becomes more stereoscopic.

A light guide or lens 2 with the same shape as displayed characters is made of translucent Acrylic materials. The inner wall 14 of the light guide has a smooth surface to let the light enter freely, and the outer wall 15 has a fine frosted surface, by which the light is diffused to form a soft luminous surface. Diffusion diluents 18 may be provided inside, so that the light entered into the light guide can be diffused and focused. The diffusion diluents 18 as illustrated are in the form of dopants dispersed in the light guide 2. The diffusion diluents may take other forms in other embodiments. For example, air gaps and/or stress fractures may be employed. An illumination channel 3 is provided at both sides under the light guide. The illumination channel 3 may be made of opaque white PPO (Poly Phenylene Oxide) materials. Illumination channel 3 and light guide 2 may be pressed to form a single piece by a secondary injection molding method, so as to make the structure of whole advertising sign simple, and simplify the technical process. As for the large-lot production, basically, the pressing process will not significantly increase the cost. The two main sides in illumination channel 3 are smooth plane surface 8, so as to increase the reflectivity of the light. Reflectable paint can also be sprayed on the two main sides.

Small recesses 20 are provided outside the illumination channel 3 and matching lobes 26 are provided on the corresponding locations of the supporting frame 1. The recesses and the lobes may be fixed by a flexible lock. A shoulder 12 is positioned on each side of illumination channel 3 for fixing the PCB when encapsulating.

Chips 5 are spacedly disposed as a linear or strip array and may be fixed on the PCB by a chip bonding method. Chips of different luminous colors may be utilized as desired to form a aesthetic advertisement.

The shape of PCB 4 is prefabricated as similar to the character shape, the side on which chips are mounted rests on shoulders 12. Because of the simple circuitry, the PCB may be made of the low-cost single-sided epoxy boards.

Light guide 2, illumination channel 3 and PCB 4 form a closed light cavity, which is encapsulated or filled, for example, with silica gel. When encapsulating, light guide 2 and illumination channel 3 may be fixed on supporting frame 1, light guide 2 is positioned at a lower position and illumination channel 3 is positioned at an upper position. Then the light cavity is filled with proper amount of silica gel. The side on which chips is mounted of PCB 4 is downwards rested on shoulders 12 of the illumination channel. The other side of PCB is locked by flexible lobes 10, which are located in the lower sides of the illumination channel. The redundant silica gel flows out from holes 13 of the PCB. The quantity of the silica gel may be controlled to make the silica gel flow out from holes 13 and thinly cover the surface of PCB.

In an embodiment of the present invention, LED chips have advantages over the previous LED lamps: saving cost and having higher light efficiency. According to an embodiment, the light emitted from chips can directly be led to the light guide through the silica gel, thus the light efficiency is higher. Furthermore, generally the viewing angle of chip light beam is large enough (lighting within 180°), so it is unnecessary to select LED lamps with large viewing angles to make light uniform.

The silica gel 6 is doped with proper amount of diffusion diluents in order to make the light in the silica gel be diffused. Then the light is uniform before it reaches the light guide, so that the light of the light guide becomes more uniform.

The silica gel has outstanding advantage in anti-aging, and the silica gel used in an embodment is put in a relatively closed environment, softer silica gel (“jelly” silica gel) can be utilized. The soft silica gel reduces the impact of chip loosening under stress on the light emission, and provides for easier maintenance.

LED chips 5 on PCB 4 may be connected with current-limiting resistors 16, and connected to the control switch by wire 9. Through the control circuit C 22 in supporting frame 1, the advertising characters can display various colors with variable luminous sequence and frequency. The control circuit 22 may be positioned within the support frame 1 so as to avoid obstructing the view of the sign.

FIG. 6 shows another embodiment wherein a method of dropping a small gel on each chip is utilized instead of filling in the whole light cavity with silica gel. The light guide may be made of a thicker structure in order to remedy address any reduced light diffusion due to lack of silica gel. Also the cost of this structure may be lower than the previous embodiment.

Summing up, LED chips are arranged as linear or strip array in the present invention according to the width of the light guide, so as to form the desired shape (for example, a straight or curved line) or strip illuminators of characters in front appearance, thus attaining the aim of advertisement. Embodiments may have the following features:

In an embodiment, there is at least one light guide on the supporting frame. The front shape is corresponds to a desired advertisement line, for example, the strokes of character or numerals with certain width. The light guide being made of translucent materials has a smooth inner wall, making light pass through, focus and diffuse inside to form a continuous luminous space. The outer wall of the light guide is a fine frosted surface, it can diffuse light and form luminous characters in appearance. The light guides are protruded from the supporting frame and have different color from the supporting frame, even when LED illuminators are not lit up, the light guides by themselves still have the advertising function.

In an embodiment, an illumination channel and a PCB are provided. The two sides of the illumination channel are made of opaque materials, stand face to face, and appear wider on top and narrower on bottom. A LED chip array fixed by a chip bonding method is lined up on a PCB located at the bottom of illumination channel. The inner sidewalls of the illumination channel are smooth, light-reflectable or coated with light-reflecting materials, therefore, the light through the reflection can only go to the sole exit—the light guide. The light guide, the two sides of illumination channel and PCBs on the bottom form a closed light cavity. The light cavity is encapsulated with encapsulating materials doped with a certain amount of diffusion diluents (such as silica gel), so that the light has been diffused before it enters into the light guide and is substantially uniform, thereby the light passed through the light guide becoming more uniform and softer. Silica gel encapsulation is characterized in good performances of anti-aging and good heat conductivity, thus this sign having excellent performance in harsh environments.

In an embodiment the luminous sign uses LED chips instead of the LED lamps being commercially available. In this way the structure can be simplified and the cost can be reduced. Meanwhile, the space formed by light guides, illumination channel and PCBs is filled in with silica gel, which leads the light from LED chips much more released to avoid the light loss. The diffusion diluents doped with silica gel can also lead the light to be diffused, so as to eliminate “Black area” of light.

An embodiment employs secondary injection molding technology to make the light guides and the sides of the illumination channel form a single piece, which is more propitious to encapsulating and assembling, thereby simplifying the technical process and making the sign more reliable.

An embodiment uses pre-formed PCBs, whose shape and orientation correspond to the advertising characters, but with a bit narrower width. LED chips are fixed on PCBs at a certain distance by chip bonding method, and then PCBs are fixed on the bottom of the light cavity to be encapsulated. There is a large area of tinning reflective face on PCBs, so that the light irradiated onto PCBs can also reflect back into the light cavity, and then reach the light guides. On the other side of PCBs, LED chips are connected to circuit power source by wires and the display can be controlled.

An embodiment uses drops of silica gel on each chip, that is, each LED chip is independently encapsulated by the gel, the whole cavity is not filled in with the silica gel. This may impact brightness, but may considerably save materials.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A luminous sign using encapsulated LED chips with a neon light effect, comprising:
at least one light guide, a front shape of which is a shape of a character with a width and height;
an illumination channel with at least one side of opaque materials, having a shape which corresponds to the shape of the light guide, the illumination channel and the light guide integrated into one piece;
at least one PCB, having a shape which corresponds to the shape of the illumination channel, being placed underneath the illumination channel;
a plurality of LED chips disposed as a strip array on the PCB by a chip bonding method;
the light guide, the illumination channel and the PCB configured to form a closed light cavity, the LED chips being encapsulated with encapsulant doped with diffusion diluent; the encapsulated light guide, illumination channel and PCB mounted on a supporting frame to form the character shape.

2. The luminous sign of claim 1 wherein the LED chips are encapsulated by separately dropping gel on each LED chip in the plurality of LED chips.

3. The luminous sign of claim 1 wherein the light guide is made of translucent materials and has an inner wall with a smooth surface and an outer wall with a fine frosted surface.

4. The luminous sign of claim 1 wherein two sides of the illumination channel are made of opaque materials, and the illumination channel is pressed with the light guide to form a single piece by a secondary injection molding, the illumination having an inner wall with a smooth reflecting surface.

5. The luminous sign of claim 1 wherein the LED chips are coupled to a controller through current-limiting resisters and wires.

6. The luminous sign of claim 1 wherein the encapsulant doped with diffusion diluent is silica gel.

7. The luminous sign of claim 6 wherein the PCB has holes for dispersing the gel.

8. The luminous sign of claim 1 wherein outer walls of the illumination channel are configured to be fixed on the supporting frame through a plurality of matching flexible clasped-structures, which are positioned at corresponding locations of the illumination channel and the supporting frame.

9. The luminous sign of claim 1 wherein shoulders and flexible clasps are provided at the lower end of the illumination channel for fixing PCBs.

10. The luminous sign of claim 1 wherein the LED chips are encapsulated by filling the cavity with the encapsulant.

11. An electric sign, comprising:
means for guiding light to form a selected shape;
means for reflecting light into the means for guiding light;
means for generating light;
means for encapsulating the means for generating light; and
means for coupling the means for generating light to the means for reflecting light.

12. The electric sign of claim 11 wherein the means for guiding light comprises a light guide having a frosted outer surface with the selected shape.

13. The electric sign of claim 12, further comprising a plurality of diffusion diluents dispersed within the light guide.

14. The electric sign of claim 11 wherein the means for generating light comprises an LED chip and the means for encapsulating the means for generating light comprises a silicon gel.

15. The electric sign of claim 11 wherein the means for generating light comprises a plurality of LED chips and the means for encapsulating comprises a silicon gel filling a cavity defined by the means for guiding light, the means for reflecting light, the means for generating light and the means for coupling the means for generating light to the means for reflecting light.

16. The electric sign of claim 11 wherein the means for generating light comprises a plurality of LED chips and the means for encapsulating comprises a corresponding plurality of drops of silicon gel deposited on respective LED chips in the plurality of LED chips.

17. The electric sign of claim 16 wherein the silicon gel comprises a soft silicon gel doped with a plurality of diffusion diluents.

18. An electric sign comprising:
a controller; and
a plurality of characters coupled to the controller, each of the plurality of characters comprising:
a circuit board having a general shape corresponding to a shape of a respective character in the plurality of characters;
a plurality of light-emitting chips covered with light-dispersing encapsulant and coupled to the circuit board;
a light-reflecting channel coupled to the circuit board; and
a lens coupled to the light-reflecting channel.

19. The electric sign of claim 18 wherein the light-dispersing encapsulant of a respective character comprises a plurality of drops of silicon gel covering respective light-emitting chips in the plurality of light-emtting chips.

20. The electric sign of claim 18 wherein the circuit board, the plurality of light-emitting chips, the light-reflecting channel and the lens of a respective character define a cavity, and the light-dispersing encapsulant comprises a silicon gel filling the defined cavity of the respective character.
